(19) United States
(12) Patent Application Publication
(10) Pub. No.: US 2003/0172171 A1
(43) Pub. Date: Sep. 11, 2003

(54) Communication control unit and information terminal unit equipped with the same

(75) Inventor: Mitsuhiro Ueno, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/291,372

(22) Filed: Nov. 12, 2002

(30) Foreign Application Priority Data
Mar. 8, 2002 (JP) 2002-063816(PAT.

(51) Int. Cl. G06F 15/16

(52) U.S. Cl. 709/230; 709/250

(57) ABSTRACT

Communication control sections prepared in accordance with plural existing protocols and the same number of virtual communication control sections are provided in advance. A port driver is interposed between the communication control section and the virtual communication control section in order to correlate a specific communication control section with a specific virtual communication control section in a one-to-one manner. An application uses the virtual communication control section that corresponds to the specified protocol. The virtual communication control section and the communication control section send/receive data to/from each other via the port driver. The port driver establishes a state of connection between the virtual communication control section that issues a connection request with the communication control section and the corresponding communication control section among plural existing virtual communication control sections and plural existing communication control sections based on the relationship of correspondence determined in advance.

### CROSS-REFERENCE TO RELATED APPLICATION

This application claims priority of Japanese Patent Application No. 2002-063816, filed on Mar. 8, 2002.

### BACKGROUND OF THE INVENTION

1. Field of the Invention

The present invention relates to a communication control unit that provides an information terminal unit with a communication facility and a portable information terminal unit equipped with such a communication control unit. More particularly, the present invention relates to a communication control unit that provides a portable information terminal unit, which has no built-in communication device and is connected to an external communication device for communication, with a communication facility, and a portable information terminal unit equipped with such a communication control unit. Such information terminal units include, for example, notebook personal computers, to which a cellular phone or a fixed-line phone is connected via a USB (Universal Serial Bus) port for communication, a PDA (Personal Digital Assistant), which establishes communication via a communication card inserted into an expansion slot, and so on.

2. Prior Art

The protocol for radio communication that uses the public phone network includes, for example, that based on PIAF (PHS Internet Access Forum) and that based on ITU-T (International Telecommunication Union, Telecommunication Standardization Sector).

Up to now, when an information terminal without a communication facility is connected to the public phone network, communication is established via a communication device such as a cellular phone, a PHS phone or a modem, connected to the information terminal. In this case, it is necessary for a user to know whether the communication device connected to the information terminal supports PIAF or ITU-T and to specify clearly the protocol to be used by the information terminal to establish communication.

FIG. 5 is a schematic diagram that illustrates the above-mentioned case.

A user needs to send a command, which is in accordance with the protocol the communication device supports, to an application 501 installed in an information terminal 500. The application 501 sends the command sent from the user to a communication driver 510. The application 501, for example, appends a suffix (it corresponds to #32 in ATDT1234#32 in the figure) to a call-originating dial command and notifies the communication driver 510 of the protocol to be used.

An input/output process section 511 of the communication driver 510 receives the call-originating command with a suffix sent from the application 501 and sends the suffix to a data analysis section 512. The data analysis section 512 analyzes the received suffix and determines a protocol to be used. The communication driver 510 establishes a communication channel with a communication device 130 by using a first communication protocol 513a or a second communication protocol 513b the data analysis section 512 has determined.

In FIG. 5, reference number 125 refers to a COM port connector, for example, such as a USB port or an expansion slot into which a communication card can be inserted. The communication device 130 is connected to the information terminal unit 500 via the COM port connector 125.

FIG. 6 is a schematic diagram of another conventional case. In the figure, reference number 600 refers to an information terminal unit, 601 to a communication application, 602 to a port process section, and reference numbers 610a and 610b refer to communication drivers. The communication driver 610a comprises an input/output process section 611a, a data analysis section 612a, and a first communication protocol 613a, and the communication driver 610b comprises an input/output process section 611b, a data analysis section 612b, and a second communication protocol 613b.

The flow of operations is the same as that of the case described above, to the point where an application 601 issues a call-originating dial command with a suffix. In this case, however, it never happens that the application 601 sends the command directly to the communication driver 610a or the communication driver 610b. The application 601 issues the command to the port 602.

When receiving the command from the application 601, the port 602 activates the first communication driver 610a, the priority of which is the highest, as determined in advance. The port 602 waits until the first communication driver is completely activated and sends thereto the call-originating dial command with a suffix sent from the application 601. The input/output process section 611a of the first communication driver 610a receives the call-originating dial command with a suffix sent from the application 601 and sends the suffix to the data analysis section 612a. The data analysis section 612a analyzes the received suffix and judges for itself whether an action in accordance with the protocol is possible.

When the data analysis section 612a judges that an action in accordance with the protocol is possible, the first communication driver 610a establishes a communication channel with the communication device 130 using the first communication protocol 613a.

Contrary to this, when the data analysis section 612a judges that an action in accordance with the protocol is impossible, the first communication driver 610a notifies the port 602 of this.

The port 602 judges that the communication device 130 cannot establish communication using the protocol with which the first communication driver 610a can operate, and activates the second communication driver 610b, the priority of which is the second highest, as determined in advance. The port 602 waits until the second communication driver is completely activated and sends thereto the call-originating dial command with a suffix sent from the application 601. The input/output process section 611b of the second communication driver 610b receives the call-originating dial command with a suffix sent from the application 601 and sends the suffix to the data analysis section 612b. The data analysis section 612b analyzes the received suffix and judges by itself whether an action in accordance with the protocol is possible.

When the data analysis section 612b judges that an action in accordance with the protocol is possible, the second communication driver 610b continues the communication with the communication device 130 using the second communication protocol 613b.

Contrary to this, when the data analysis section 612b judges that an action in accordance with the protocol is impossible, the second communication driver 610b notifies the port 602 of this.

After this, the port repeats the above-mentioned process for all the available communication drivers, until communication is established, successively.

The method, however, which requires the user to recognize the command specifications of the communication device 130, is too complicated.

On the other hand, as it takes a comparably long time to activate a driver that requires loading and initialization of a program, it is difficult to quickly establish communication with a method in which communication drivers are sequentially switched when communication cannot be established.

### SUMMARY OF THE INVENTION

The present invention, therefore, provides in advance plural communication control units that correspond to plural existing protocols and the same number of virtual communication control units. A port driver is interposed between the communication control unit and the virtual communication control unit in order to correlate them in a one-to-one relationship. As the virtual communication control section is provided in correspondence to each protocol, the application uses the virtual communication control section that corresponds to the specified protocol.

The virtual communication control section and the communication control section send/receive data to/from each other via the port driver. The port driver establishes a state of connection between the virtual communication control section that requests connection to a communication control section and the corresponding communication control section among the plural existing virtual communication control sections and the plural existing communication control sections based on the relationship of correspondence between the virtual communication control sections and the communication control sections determined in advance.

The port driver maintains the state of connection until the end of the communication after the connection between the virtual communication control section and the communication control section is once established, and does not accept any connection request from other virtual communication control sections.

According to the first aspect of the present invention, a communication control unit is provided, which comprises a first communication control unit that establishes communication with a first external device via a physical communication port according to a first protocol, a second communication control unit that establishes communication with a second external device via the physical communication port according to a second protocol, a first virtual communication control section that provides a communication application with a first logical communication port, a second virtual communication control section that provides the communication application with a second logical communication port, and a port driver, which establishes communication between the first virtual communication control section and the physical communication port via the first communication control section by connecting logically the first communication control unit and the first virtual communication control unit when a connection request is issued from the first virtual communication control unit to the communication control sections, and which establishes communication between the second virtual communication control section and the physical communication port via the second communication control section by connecting logically the second communication control unit and the second virtual communication control unit when a connection request is issued from the second virtual communication control unit to the communication control sections.

In the unit described above, when a request for communication is issued from the communication application to, for example, the first virtual communication control section that corresponds to the specified protocol, the first virtual communication control section issues a request for connection with the communication control section to the port driver. In response to this connection request, the port driver selects the first communication control section that corresponds to the first virtual communication control section and establishes communication between the first virtual communication control section and the physical communication port via the first communication control section as well as connecting logically therebetween. Once connection with the first or the second virtual communication control section is established, the port driver maintains the state of connection until the end of the communication and does not accept any connection request from other virtual communication control sections. When the connection request from the communication application is for the second virtual communication control section, the port driver selects the second communication control section and establishes communication between the second virtual communication control section and the physical communication port via the second communication control section.

The port driver has a correspondence table relating the logical connections between the first and the second virtual communication control sections and the first and the second communication control sections and refers to this correspondence table to select a communication control section to be connected, when a connection request is issued from the first and the second virtual communication control sections to the communication control sections.

Plural virtual communication control sections and communication control sections can be provided in accordance with plural protocols.

The above-mentioned communication control unit is incorporated into an information terminal unit such as a notebook personal computer or a PDA, and provides the information terminal unit with the communication facility that can correspond to plural protocols. In this case, the physical communication port corresponds to the COM port connector and the logical communication port corresponds to the COM port. The first and the second virtual communication control sections and the port driver can be provided by the OS and the first and the second communication control sections can be provided by the device driver. Moreover, it is possible for the communication application to comprise a means by which a user can select either the first or the second virtual communication control section in advance.

### BRIEF DESCRIPTION OF THE DRAWINGS

FIG. 1 is a block diagram that shows a communication control unit in one of the embodiments of the present invention.

FIG. 2 is a diagram that shows the process flow of the communication control unit shown in FIG. 1.

FIG. 3 is a diagram that shows the relationship of correspondences between the virtual communication control sections and the communication control sections in the communication control unit.

FIG. 4 is a diagram that shows the process flow to open the COM port in the communication control unit shown in FIG. 1

FIG. 5 is a block diagram that shows the first example of a conventional communication control unit.

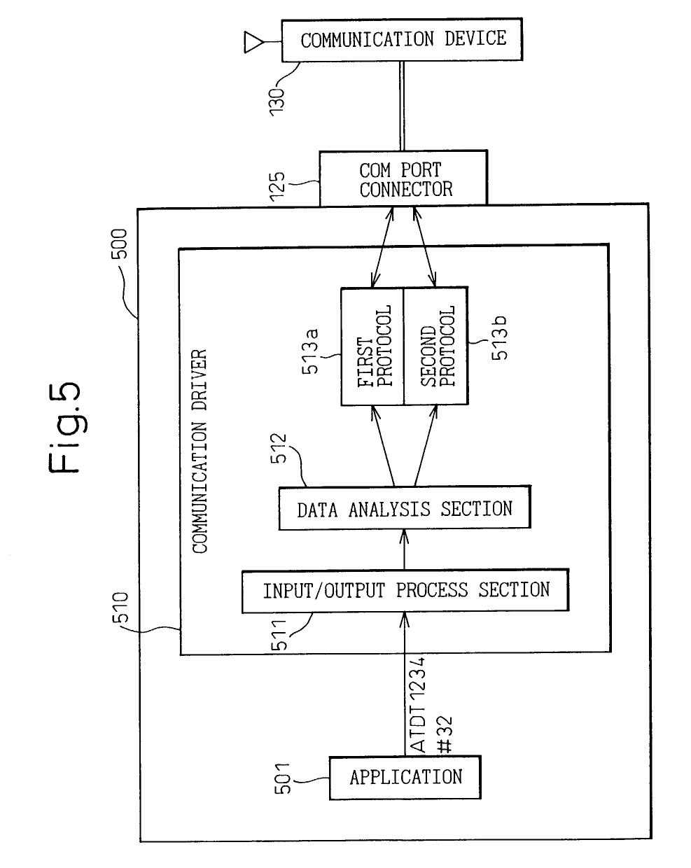

FIG. 6 is a block diagram that shows the second example of a conventional communication control unit.

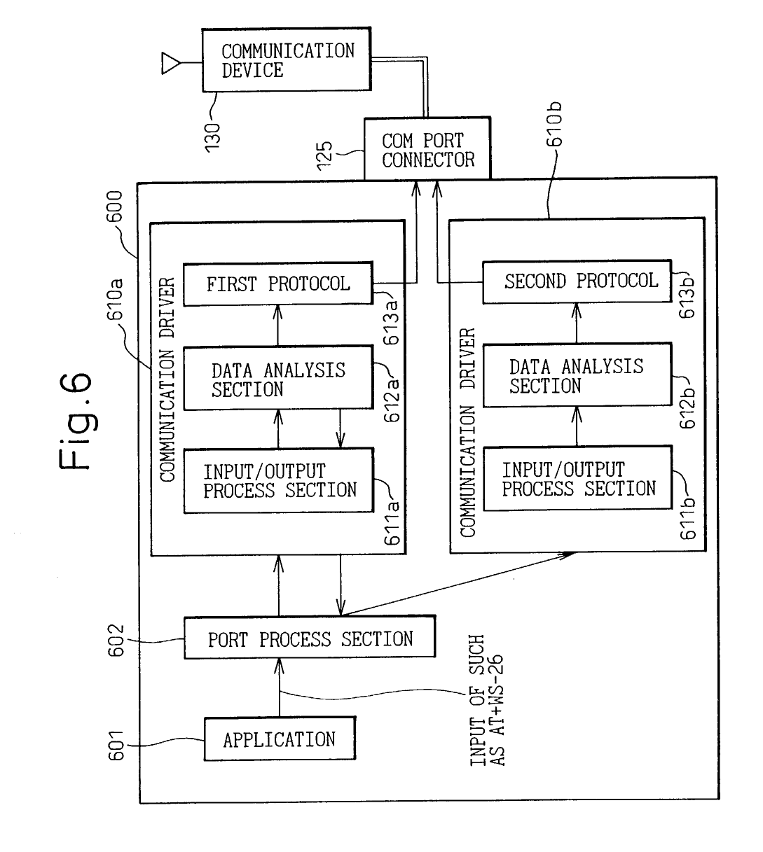

### DESCRIPTION OF THE PREFERRED EMBODIMENTS

The preferred embodiments of the present invention are described below with reference to drawings.

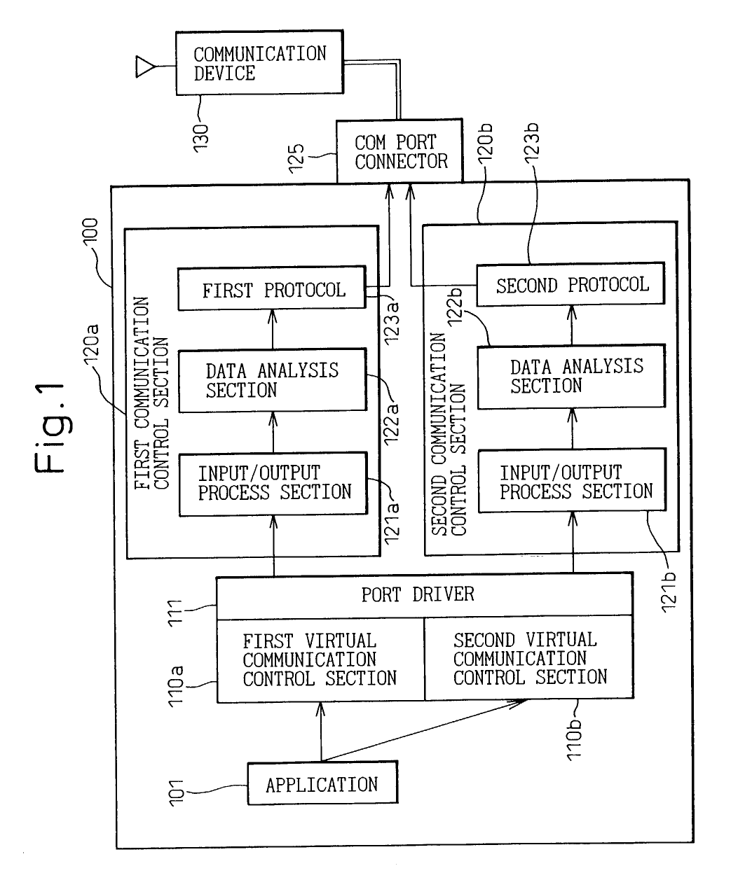

FIG. 1 is a diagram that shows the first embodiment of the present invention.

An information terminal 100 usually comprises plural physical communication ports. Usually these are called the COM ports. The application can selectively use a specific COM port. The term COM port may refer to an input/output interface that can be viewed from the application, or may refer to a physical connector circuit for external connection provided to the information terminal. Moreover, it may be used as a term that includes both in an extended meaning. In the present specifications, the COM port means an input/output interface that can be viewed from the application. In addition, the physical connecter circuit for external connection provided to the information terminal is called the COM port connector.

Usually, an OS and a software program called a device driver are interposed between the application and the COM port connector. The device driver controls the electric circuits of the hardware COM port connecter as well as providing an input/output interface for the COM port connecter to the application. The presence of the device driver obviates the necessity of modifying the OS and the application even though the control method of the COM port connector in a hardware manner is modified. The modification of the COM port connector in a hardware manner is compensated for by modification of the device driver. Because of this, generally the manufacturer of the hardware, which is the target of control, provides the device driver.

The virtual communication control section, the port driver, and the communication control section referred to in the present invention are configured by the OS and the device driver. Generally, the virtual communication control section and the port driver are provided by the OS and the communication control section is provided by the device driver.

In FIG. 1, reference number 100 refers to the portable information terminal unit in the first embodiment of the present invention. This unit 100 comprises an application 101, which is communication software, first and second virtual communication control sections 110a and 110b, a port driver 111, and first and second communication control sections 120a and 120b. The number of the first and second virtual communication control sections 110a and 110b is not limited to two, but plural sections can be provided. In this case, a corresponding number of the communication control sections are provided. Basically, the first and the second communication control sections 120a and 120b comprise an input/output process section 121a or 121b, a data analysis section 122a or 122b, and a first or second protocol 123a or 123b, similarly to the case of a conventional one.

It is designed so that the virtual communication control sections 110a and 110b are viewed from the application 101 as a COM1 port and a COM2 port. As well as the port driver 111, these are provided by the OS (Operating System), as described above. The application 101 has a procedure by which it is possible for a user to select in advance to use the COM1 port or the COM2 port as a communication port. The user selects the COM port on the application, which corresponds to a protocol supported by the external communication device 130 to be connected to the portable terminal unit 100 for use.

Or, the user selects and specifies the name of an external communication unit to be connected to the terminal unit 100 from the names of external communication unit listed on the application 101. In this case, the name of an external communication unit and a COM port in accordance with the protocol the device supports are made to correspond to each other in advance by the application 101. The external communication device 130 is connected to the portable terminal unit 100 via the COM port connector 125 provided to the portable terminal unit 100.

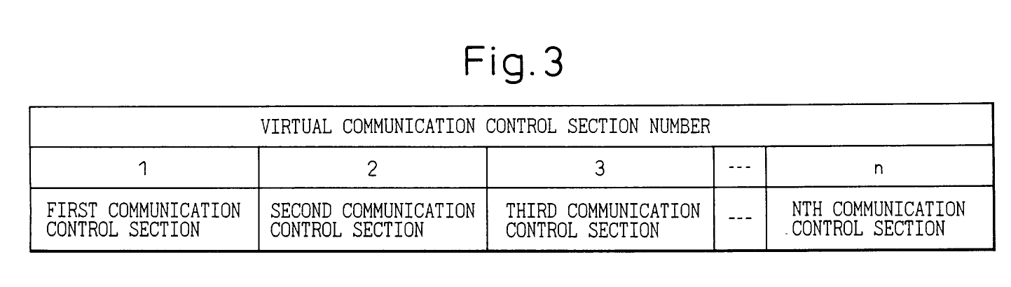

The port driver 111 has, internally, a communication control section correspondence table as shown in FIG. 3, with which the correspondences between the first and second virtual communication control sections 110a and 110b and the communication control sections 120a and 120b are determined, and connects the COM port (virtual communication control section) selected by a user to a corresponding communication control section based on the table.

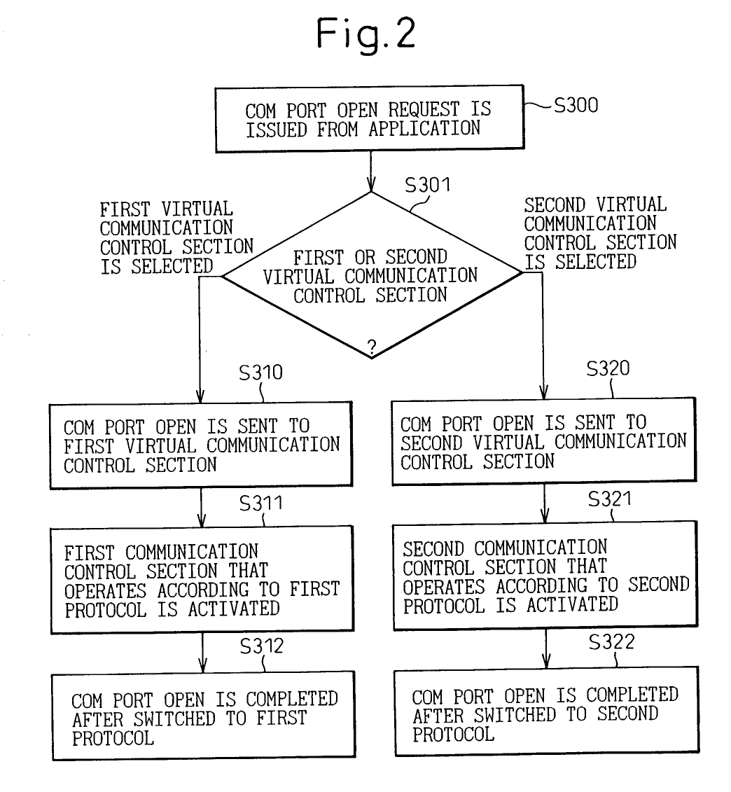

The operations of the unit in FIG. 1 are described below with reference to the flow chart in FIG. 2.

When a communication request is issued, the application 101 issues an open request for the COM port specified in advance by the user (step S300.) Then, the application 101 judges whether the issued COM port open request is for the first virtual communication control section 110a or for the second virtual communication control section 110b (step S301.) When it is judged that the COM port open request is for the first virtual communication control section 110a, the application 101 notifies the first virtual communication control section 110a of the COM port open in step S310. On the other hand, when it is judged that the COM port open request is for the second virtual communication control section 110b in step S301, the application 101 notifies the second virtual communication control section 110b of the COM port open (step S320.)

When the issued COM port open request is for the second virtual communication control section 110b and the second virtual communication control section 110b accepts the COM port open request, it requests the port drive 111 to establish connection with a communication control section. The port driver 111 refers to the communication control section correspondence table shown in FIG. 3, recognizes that the communication control section that corresponds to the second virtual communication control section 110b is the second communication control section 120b, and activates the second communication control section 120b (step S321.) Then, the port driver 111 establishes a logical communication between the second virtual communication control section 110b and the second communication control section 120b, completes the COM port open, and notifies the application 101 of this.

The input/output process sections 121a and 121b, the data analysis sections 122a and 122b, and the protocols 123a and 123b provided to the first communication control section 120a and the second communication control section 120b are the same as the conventional ones.

After the COM port open is completed, communication is enabled between the application 101 and the communication device 130 via the virtual communication control section 110b, which is the COM port, the port driver 111, the communication control section 120b, and the COM port connector 125.

In the embodiment described above, the case where the information device supports two kinds of protocols is described for simplicity. However, the present invention can be applied to the case where available protocols are three or more. Moreover, it can be predicted that the more available protocols there are, the more outstanding the effects of the present invention become.

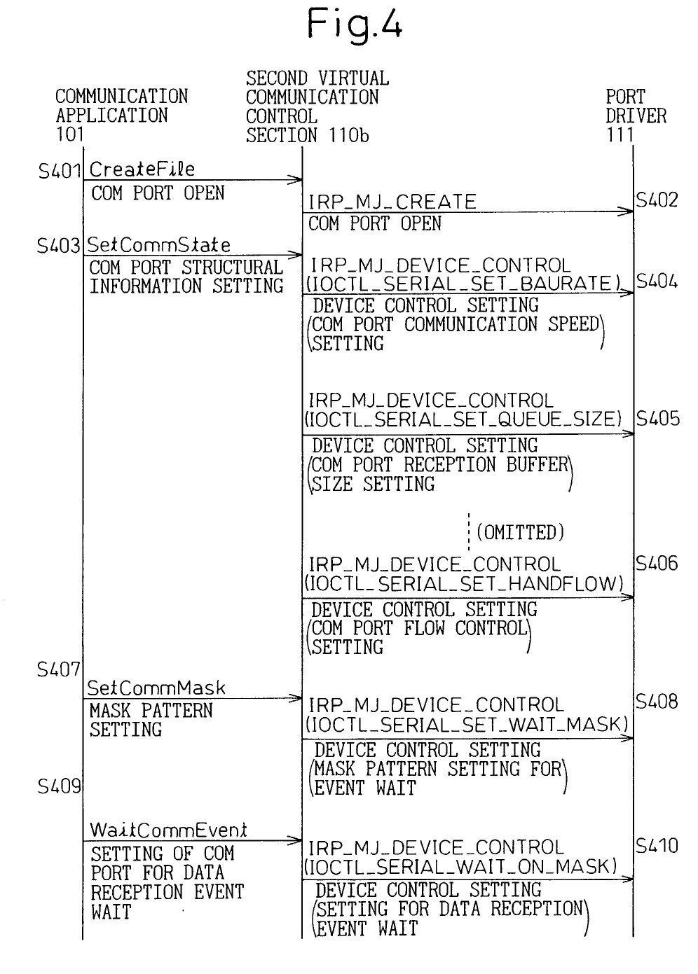

Next, with reference to FIG. 4, a concrete procedure, in which the application 101 completes the COM port open in the above-mentioned case, is described below.

The application 101 sends a CreateFile command that requests to open the COM port to the second virtual communication control section 111b (S401.) The virtual communication control section 110b sends an IRP#MJ#CREATE command, which notifies that there is a COM port open request, to the port driver 111 (S402.)

The port driver 111 refers to the communication control section correspondence table in FIG. 3 described above, and recognizes that the communication control section that corresponds to the second virtual communication control section 110b is the second communication control section 120b. The port driver 111 establishes a logical connection between the second virtual communication control section 110b and the second communication control section 120b, whereby communication between them is enabled thereafter.

The second virtual communication control section 110b and the second communication control section 120b are controlled so that they cannot establish any communication other than that between them.

The application 101 sends a SetCommState command, which sets the structural information of the COM port, to the virtual communication control section 110b (S403.) Using this command, the application 101 notifies the virtual communication control section 110b of the communication speed of the COM port connector 125 or the communication control section 120b, the reception buffer size of the COM port connector 125 or the communication control section 120b, the flow control settings of the COM port connector 125 or the communication control section 120b, and so on.

The virtual communication control section 110b sets the structural information of the COM port connector 125 or the communication control section 120b for the port driver 111. The settings of the structural information are carried out by an IRP#MJ#DEVICE#CONTROL command, but the IRP#MJ#DEVICE#CONTROL command has a structure in which two or more pieces of setting information cannot be notified. Therefore, the virtual communication control section 110b first sends an IRP#MJ#DEVICE#CONTROL (IOCTL#SERIAL#SET#BAURATE) command in order to carry out the setting of the communication speed (S404.)

Next, the virtual communication control section 110b sends an IRP#MJ#DEVICE#CONTROL (IOCTL#SERIAL#SET#QUEUE#SIZE) command to the port driver 111 in order to carry out the setting of the reception buffer size (S405.)

Then, the virtual communication control section 110b sends a command such as an IRP#MJ#DEVICE#CONTROL (IOCTL#SERIAL#SET#HANDFLOW) command to the port driver 111 and completes the settings for the COM port connector 125 or the communication control section 120b.

The application 101 issues a SetCmmMask command to the virtual communication control section 110b (S407) so that an interrupt mask pattern for data from the external device connected to the communication port (COM 2 port) can be set in the virtual communication control section. This setting is that the application 101 sets conditions for blocking an interruption from the external device.

The virtual communication control section 110b sends an IRP#MJ#DEVICE#CONTROL (IOCTL#SERIAL#SET#WAIT#MASK) command to the port driver 111 (S408) so that the port driver 111 can set device control information in the COM port connector 125 or in the communication control section 120b.

Thus, the initial settings that need to be performed prior to communication are completed.

The application 101 sends a WaitCommEvent indicating that it will wait until data is sent from the communication port (COM 2 port.)

The virtual communication control section 110b issues an IRP#MJ#DEVICE#CONTROL (IOCTL#SERIAL#WAIT#ON#MASK) command indicating that it will wait until data is sent from the COM port connector 125 or the communication control section 120b to the port driver 111 (S410.)

The initialization of the communication channel that needs to be performed prior to communication is thus completed and the transmission and reception of data are enabled.

[Effects of the Invention]

As described above, the following effects can be obtained by the present invention.

(1) By providing communication control sections that correspond to plural protocols, a user is required only to notify the application of the communication control section that corresponds to the communication device to be used. As a result, the user does not have to understand the command system that corresponds to the communication device, resulting in reduction of the burden on the user.

(2) Since the port driver can selectively activate the communication control section in accordance with the protocol the communication device supports, it is not necessary to check all the prepared communication control sections, and a communication channel can be established quickly.

(3) Communication via plural virtual communication control sections (COM ports) is performed physically for the same COM port connector. In other words, even if it seems to the application that different communication devices are used according to the settings of the users, the same physical communication device is actually used even though it is used via virtual communication control sections (COM ports).

Because of these, the user can connect the communication device to the same COM port connector, resulting in an improvement in usability.

(4) Since each communication control section needs only to have a function in accordance with the single protocol, the volume can be reduced. By this, the program can be made more compact and the load time into the memory can be reduced.

What is claimed is:

1. A communication control unit comprising a first communication control section that communicates with an external device via a communication port based on a first protocol, a second communication control section that communicates with the external device via the communication port based on a second protocol, a first virtual communication control section that relays communication, a second virtual communication control section, which is different from the first virtual communication control section and relays communication, and a port driver, which establishes communication between the first virtual communication control section and the communication port via the first communication control section when a connection is requested by the first virtual communication control section to the communication control section, and which establishes communication between the second virtual communication control section and the communication port via the second communication control section when a connection is requested by the second virtual communication control section to the communication control section.

2. A communication control unit, as set forth in claim 1, wherein said port driver establishes a logical connection between the first communication control section and the first virtual communication control section to establish said communication between the first virtual communication control section and the communication port via the first communication control section when a connection is requested by the first virtual communication control section to the communication control section, and establishes a logical connection between the second communication control section and the second virtual communication control section to establish said communication between the second virtual communication control section and the communication port via the second communication control section when a connection is requested by the second virtual communication control section to the communication control section.

3. A communication control program that controls a computer, said computer comprising a first communication control section that communicates with an external device via a communication port based on a first protocol, a first virtual communication control section that provides software with a logical port for communication, a second communication control section that communicates with an external device via the communication port based on a second protocol, and a second virtual communication control section, which is different from the first virtual communication control section and provides software with a logical port for communication, said program making said computer performing a step to establish communication between the first virtual communication control section and the communication port via the first communication control section when a connection is requested by the first virtual communication control section to the communication control section, and a step to establish communication between the second virtual communication control section and the communication port via the second communication control section when a connection is requested by the second virtual communication control section to the communication control section.

4. A communication control method of a computer, said computer comprising a first communication control section that communicates with an external device via a communication port based on a first protocol, a first virtual communication control section that provides software with a logical port for communication, a second communication control section that communicates with an external device via the communication port based on a second protocol, and a second virtual communication control section, which is different from the first virtual communication control section and provides software with a logical port for communication, said method including a step to establish communication between the first virtual communication control section and the communication port via the first communication control section when a connection is requested by the first virtual communication control section to the communication control section, and a step to establish communication between the second virtual communication control section and the communication port via the second communication control section when a connection is requested by the second virtual communication control section to the communication control section.

5. An information communication terminal equipped with the communication control unit, as set forth in claim 1.

6. A recording medium that stores the communication control program, as set forth in claim 3.

7. A communication control unit that comprises a first communication control section that communicates with a first external device via a physical communication port based on a first protocol, a second communication control section that communicates with a second external device via the physical communication port based on a second protocol, a first virtual communication control section that provides a communication application with a first logical communication port, a second virtual communication control section that provides the communication application with a second logical communication port, and a port driver, which establishes communication between the first virtual communication control section and the physical communication port via the first communication control section when a connection is requested by the first virtual communication control section to the communication control section, and which establishes communication between the second virtual communication control section and the physical communication port via the second communication control section when a connection is requested by the second virtual communication control section to the communication control section.

8. A communication control unit, as set forth in claim 7, wherein said port driver establishes a logical connection between the first communication control section and the first virtual communication control section to establish said communication between the first virtual communication control section and the physical communication port via the first communication control section when a connection is requested by the first virtual communication control section to the communication control section, and establishes a logical connection between the second communication control section and the second virtual communication control section to establish said communication between the second virtual communication control section and the physical communication port via the second communication control section when a connection is requested by the second virtual communication control section to the communication control section.

9. A communication control unit, as set forth in claim 8, wherein the port driver has a correspondence table relating logical connections between the first and the second virtual communication control sections and the first and the second communication control sections.

10. A communication control unit, as set forth in claim 7, wherein the first and the second virtual communication control sections send out a connect request with the communication control section to the port driver when receiving a communication request from the communication application.

11. A communication control program that controls a computer, said computer comprising a first communication control section that communicates with a first external device via a physical communication port based on a first protocol, a second communication control section that communicates with a second external device via the physical communication port based on a second protocol, a first virtual communication control section that provides a communication application with a first logical communication port, and a second virtual communication control section that provides the communication application with a second logical communication port, said program making said computer performing a step to establish communication between the first virtual communication control section and the physical communication port via the first communication control section when a connection is requested by the first virtual communication control section to the communication control section, and a step to establish communication between the second virtual communication control section and the physical communication port via the second communication control section out when a connection is requested by the second virtual communication control section to the communication control section.

12. A communication control method of a computer, said computer comprising a first communication control section that communicates with a first external device via a physical communication port based on a first protocol, a second communication control section that communicates with a second external device via the physical communication port based on a second protocol, a first virtual communication control section that provides a communication application with a first logical communication port, and a second virtual communication control section that provides the communication application with a second logical communication port, said method including a step to establish communication between the first virtual communication control section and the physical communication port via the first communication control section when a connection is requested by the first virtual communication control section to the communication control section, and a step to establish communication between the second virtual communication control section and the physical communication port via the second communication control section when a connection is requested by the second virtual communication control section to the communication control section.

13. An information terminal unit that comprises a first communication control section that communicates with a first external device via a physical communication port based on a first protocol, a second communication control section that communicates with a second external device via the physical communication port based on a second protocol, a first virtual communication control section that provides a communication application with a first logical communication port, a second virtual communication control section that provides the communication application with a second logical communication port, and a port driver, which establishes communication between the first virtual communication control section and the physical communication port via the first communication control section when a connection is requested by the first virtual communication control section to the communication control section, and which establishes communication between the second virtual communication control section and the physical communication port via the second communication control section when a connection is requested by the second virtual communication control section to the communication control section.

14. An information terminal unit, as set forth in claim 13, wherein the physical communication port is a COM port connector and the logical communication port is a COM port.

15. An information terminal unit, as set forth in claim 13, wherein the first and the second virtual communication control sections and the port driver are provided by an OS and the first and the second communication control sections are provided by a device driver.

16. An information terminal unit, as set forth in claim 13, wherein the port driver has a correspondence table relating to logical connections between the first and the second virtual communication control sections and the first and the second control sections.

17. An information terminal unit, as set forth in claim 13, wherein the first and the second virtual communication control sections send out a connect request with the communication control section to the port driver when receiving a communication request from the communication application.

18. An information terminal unit, as set forth in claim 13, wherein the communication application comprises a step by which a user is enabled to select in advance either the first or the second virtual communication control section.
